(19) United States
(12) Patent Application Publication
(10) Pub. No.: US 2023/0189307 A1
(43) Pub. Date: Jun. 15, 2023

(54) METHOD PERFORMED BY USER EQUIPMENT, AND USER EQUIPMENT

(71) Applicant: Sharp Kabushiki Kaisha, Sakai City, Osaka (JP)

(72) Inventors: Renmao LIU, Shanghai (CN); Chao LUO, Shanghai (CN); Fangying XIAO, Shanghai (CN)

(21) Appl. No.: 17/912,564

(22) PCT Filed: Mar. 23, 2021
(86) PCT No.: PCT/CN2021/082354

§ 371 Date: Sep. 19, 2022

(30) Foreign Application Priority Data
Mar. 26, 2020 (CN) 202010226206.1

(51) Int. Cl. H04W 72/51; H04W 72/23

(52) U.S. Cl. CPC H04W 72/51; H04W 72/23

(57) ABSTRACT

Provided is a method performed by user equipment (UE), including: detecting a synchronization signal/physical broadcast channel block, i.e. an SS/PBCH block; determining, according to the detected SS/PBCH block and from a master information block (MIB), whether a base station transmitting the SS/PBCH block supports reduced capability UE; and if the base station supports reduced capability UE, determining a control resource set and a physical downlink control channel (PDCCH) monitoring occasion of a PDCCH search space set for receiving a reduced capability version of system information block 1, i.e. SIB1.

### TECHNICAL FIELD

The present invention relates to the technical field of wireless communications. More specifically, the present invention relates to a method performed by user equipment, and the user equipment.

### BACKGROUND

In Sep. 2019, at the 3rd Generation Partnership Project (3GPP) RAN#86 Plenary Session, a new research project on support of reduced capability NR (5th generation wireless access technology) devices (see RP-193238: New SID on support of reduced capability NR devices) was approved. One of the goals of the research project described above is to support user equipment (UE) bandwidth reduction, but the SSB (SS/PBSCH block) bandwidth of Rel-15 should be reused, and changes in a physical layer should be minimized.

In the email discussion on NR-light (see RP-192160: Summary of email discussion on NR-Light), many companies proposed that for FR1 (Frequency Range 1), the reduced UE bandwidth should be 5 MHz or 10 MHz. How to support reduced bandwidth UE in NR is a problem that must be solved.

The present disclosure primarily solves the problem of how to support reduced bandwidth UE in NR.

### SUMMARY

In order to solve at least a part of the above problems, the present invention provides a method performed by user equipment and the user equipment, which can effectively support reduced bandwidth UE in NR.

According to the present invention, a method performed by user equipment (UE) is provided, characterized by comprising: detecting a synchronization signal/physical broadcast channel block, i.e. an SS/PBCH block; determining, according to the detected SS/PBCH block and from a master information block (MIB), whether a base station transmitting the SS/PBCH block supports reduced capability UE; and if so, determining a control resource set and a physical downlink control channel (PDCCH) monitoring occasion of a PDCCH search space set for receiving a reduced capability version of system information block 1, i.e. SIB1.

Preferably, a spare bit in the MIB and an SSB subcarrier offset K_{SSB} are used for determining whether the base station supports reduced capability UE, and for determining the control resource set and the PDCCH monitoring occasion of the PDCCH search space set for receiving the reduced capability version of SIB 1.

Preferably, if the value of the spare bit is a first value, it indicates that the base station does not support reduced capability UE; if the value of the spare bit is a second value, it indicates that the base station supports reduced capability UE; in the event that the value of the spare bit is the second value, if K_{SSB} is a given value, then the control resource set and the PDCCH monitoring occasion of the PDCCH search space set for receiving the reduced capability version of SIB1 are indicated by a pdcch-ConfigSIB1 parameter in the MIB; and if K_{SSB} is not the given value, the control resource set and the PDCCH monitoring occasion of the PDCCH search space set for receiving the reduced capability version of SIB1 are determined by means of a predefined PDCCH search space set.

Preferably, the control resource set of the PDCCH search space set is obtained by means of a fixed offset relative to the detected SS/PBCH block in the frequency domain.

Preferably, the spare bit in the MIB is used for determining whether a base station supports reduced capability UE, and for determining the control resource set and the PDCCH monitoring occasion of the PDCCH search space set for receiving the reduced capability version of SIB1.

Preferably, if the value of the spare bit is a first value, it indicates that the base station does not support reduced capability UE; if the value of the spare bit is a second value, it indicates that the base station supports reduced capability UE; and in the event that the value of the spare bit is the second value, the pdcch-ConfigSIB1 parameter in the MIB may only configure a partial subset of a bandwidth set of a control resource set of the Type0-PDCCH common search space set, bandwidths in the subset being equal to or less than the bandwidth of the supported reduced capability UE.

Preferably, if the value of the spare bit is a first value, it indicates that the base station does not support reduced capability UE; if the value of the spare bit is a second value, it indicates that the base station supports reduced capability UE; in the event that the value of the spare bit is the second value, if the bandwidth in the control resource set of the Type0-PDCCH common search space set indicated by the pdcch-ConfigSIB1 parameter in the MIB is equal to or less than the bandwidth of supported reduced capability UE, then the pdcch-ConfigSIB1 parameter in the MIB is directly used for determining the control resource set and the PDCCH monitoring occasion of the PDCCH search space set for receiving the reduced capability version of SIB1; and if the bandwidth in the control resource set of the Type0-PDCCH common search space set indicated by the pdcch-ConfigSIB1 parameter in the MIB is greater than the bandwidth of the supported reduced capability UE, then the supported reduced capability UE uses a bandwidth part of the bandwidth in the control resource set of the Type0-PDCCH common search space set indicated by the pdcch-ConfigSIB1 parameter in the MIB as the bandwidth of the control resource set of the PDCCH search space set for receiving the reduced capability version of SIB1.

Preferably, the bandwidth of the control resource set of the PDCCH search space set for receiving the reduced capability version of SIB1 is equal to the bandwidth of the supported reduced capability UE, and has a starting position in the frequency domain the same as the starting position of the bandwidth of the control resource set of the Type0-PDCCH common search space set indicated by the pdcch-ConfigSIB1 parameter in the MIB.

Preferably, the number of time slot symbols in the control resource set of the PDCCH search space set for receiving the reduced capability version of SIB1 is consistent with the number of time slot symbols in the control resource set of the Type0-PDCCH common search space set indicated by the pdcch-ConfigSIB1 parameter in the MIB; and the PDCCH monitoring occasion of the PDCCH search space set for receiving the reduced capability version of SIB1 is consistent with the PDCCH monitoring occasion of the Type0-PDCCH common search space set.

In addition, according to the present invention, user equipment is provided, comprising: a processor; and a memory, stored with instructions, wherein the instructions, when run by the processor, perform the method described according to any one of claims 1 to 9.

According to the present invention, reduced bandwidth UE can be efficiently supported in NR.

### BRIEF DESCRIPTION OF THE DRAWINGS

The above and other features of the present invention will be more apparent from the following detailed description in combination with the accompanying drawings, in which:

FIG. 1 shows a flowchart of a method performed by user equipment according to Embodiment 1 of the present invention.

FIG. 2 shows a flowchart of a method performed by user equipment according to Embodiment 2 of the present invention.

FIG. 3 shows a flowchart of a method performed by user equipment according to Embodiment 3 of the present invention.

FIG. 4 is a block diagram showing the user equipment (UE) according to the present invention.

### DETAILED DESCRIPTION

In NR, system information (SI) includes a master information block (MIB) and a plurality of system information blocks (SIB). The MIB contains relevant parameters required for acquiring system information block 1 (SIB1).

The SIB1 is transmitted on a downlink shared channel (DL-SCH) with a periodicity of 160 ms, and may have variable transmission repetition periodicity within 160 ms. The default transmission repetition periodicity of SIB1 is 20 ms, but the actual transmission repetition periodicity is up to network implementation. For synchronization signal block (SSB) (or SS/PBCH block) and control resource set (CORESET) multiplexing pattern 1, the SIB1 transmission repetition period is 20 ms. For SSB and CORESET multiplexing pattern 2/3, the SIB1 transmission repetition period is the same as the SSB period. SIB1 includes information about the availability and scheduling of other SIBs (e.g. mapping of SIBs to SI message, periodicity, and SI window size). SIB1 is a cell (or base station) specific SIB.

The master information block includes parameters such as systemFrameNumber, subCarrierSpacingCommon, ssb-SubcarrierOffset, dmrs-TypeA-Position, pdcch-ConfigSIB1, cellBarred, intraFreqReselection, and spare.

ssb-SubcarrierOffset corresponds to K_{SSB}, in units of the number of subcarriers, and refers to a frequency domain offset between the SSB and the overall resource block grid. The value range of this field may be extended by an additional most significant bit encoded in a physical broadcast channel (PBCH). This field may indicate that the base station does not provide SIB1 and that there is hence no CORESET#0 configured in the MIB.

In many cases, the requirements of the entire NR RF (radio frequency) specification are defined for different frequency ranges (FR), respectively. The frequency range for NR operation is shown in Table 1.

TABLE 1
Frequency range defined in NR

| Frequency range | |
|---|---|
| designation | Corresponding frequency range |
| FR1 | 410 MHz-7125 MHz |
| FR2 | 24250 MHz-52600 MHz |

For FR1, K_{SSB} is defined as follows:
0≤K_{SSB}≤23 indicates that CORESET#0 is configured in the MIB, and indicates the size of the frequency domain offset between the SS/PBCH block and the overall resource block grid.
24≤K_{SSB}≤29 indicates that no CORESET#0 is configured in the MIB, and indicates the offset N_{GSCN}^{Offset} of the Global Synchronization Channel Number (GSCN) of an SS/PBCH block with the CORESET#0 closest to the monitored SS/PBCH block in the frequency domain relative to the monitored SS/PBCH, as shown in Table 2.
K_{SSB}=30 indicates that no CORESET#0 is configured in the MIB, and the value of the corresponding N_{GSCN}^{Offset} is reserved, as shown in Table 2.
K_{SSB}=31 indicates that no CORESET#0 is configured in the MIB, and an SS/PBCH block with the CORESET#0 is present inside the GSCN range of [N_{GSCN}^{Reference}-N_{GSCN}^{Start}, N_{GSCN}^{Reference}+N_{GSCN}^{End}], where N_{GSCN}^{Start} and N_{GSCN}^{End} are determined by controlResourceSetZero and searchSpaceZero in pdcch-ConfigSIB1, respectively, and N_{GSCN}^{Reference} is the GSCN of the SS/PBCH block monitored by the UE (user equipment).

TABLE 2
Mapping between the combination of k_{SSB} and
controlResourceSetZero and searchSpaceZero in pdcch-ConfigSIB1
to N_{GSCN}^{Offset} for FR1

| | 16 × controlResourceSetZero + | |
|---|---|---|
| k_{SSB} | searchSpaceZero | N_{GSCN}^{Offset} |
| 24 | 0, 1, . . . , 255 | 1, 2, . . . , 256 |
| 25 | 0, 1, . . . , 255 | 257, 258, . . . , 512 |
| 26 | 0, 1, . . . , 255 | 513, 514, . . . , 768 |
| 27 | 0, 1, . . . , 255 | −1, −2, . . . , −256 |
| 28 | 0, 1, . . . , 255 | −257, −258, . . . , −512 |
| 29 | 0, 1, . . . , 255 | −513, −514, . . . , −768 |
| 30 | 0, 1, . . . , 255 | Reserved, Reserved, . . . , |
| | | Reserved |

For FR2, K_{SSB} is defined as follows:
0<K_{SSB}≤11 indicates that CORESET#0 is configured in the MIB, and indicates the size of the frequency domain offset between the SS/PBCH block and the overall resource block grid.
12<K_{SSB}≤13 indicates that no CORESET#0 is configured in the MIB, and indicates the offset N_{GSCN}^{Offset} of the Global Synchronization Channel Number (GSCN) of an SS/PBCH block with the CORESET#0 closest to the monitored SS/PBCH block in the frequency domain relative to the monitored SS/PBCH, as shown in Table 3.
K_{SSB}=14 indicates that no CORESET#0 is configured in the MIB, and the value of the corresponding N(7,¹¹,⁵,' is reserved, as shown in Table 3.
K_{SSB}=15 indicates that no CORESET#0 is configured in the MIB, and an SS/PBCH block with the CORESET#0 is present inside the GSCN range of [N_{GSCN}^{Reference}-N_{GSCN}^{Start}, N_{GSCN}^{Reference}+N_{GSCN}^{End}], where N_{GSCN}^{Start} and N_{GSCN}^{End} are determined by controlResourceSetZero and searchSpaceZero in pdcch-ConfigSIB1, respectively, and _{N}Referen e ᵢₛ thₑ GSCN of the SS/PBCH block monitored by the UE.

TABLE 3
Mapping between the combination of k_{SSB} and
controlResourceSetZero and searchSpaceZero in pdcch-ConfigSIB1
to N_{GSCN}^{Offset} for FR2

| | 16 × controlResourceSetZero + | |
|---|---|---|
| k_{SSB} | searchSpaceZero | N_{GSCN}^{Offset} |
| 12 | 0, 1, . . . , 255 | 1, 2, . . . , 256 |
| 13 | 0, 1, . . . , 255 | −1, −2, . . . , −256 |
| 14 | 0, 1, . . . , 255 | Reserved, Reserved, . . . , |
| | | Reserved |

The field pdcch-ConfigSIB1 in the MIB determines a common control resource set (CORESET), a common search space, and necessary physical downlink control channel (PDCCH) parameters. If the field ssb-SubcarrierOffset indicates that no SIB1 is present, then the field pdcch-configsibl indicates frequency positions where UE may find an SS/PBCH block with SIB1, or indicates the frequency range where the network does not provide an SS/PBCH block with SIB1.

There is a spare field (spare) which is 1 bit in length in the MIB. That is, one spare bit in the MIB may be used for later versions of extension.

To access the NR network, the UE must undergo processes such as cell search, acquisition of cell system information, and random access.

Cell search is a process for the UE to acquire time and frequency synchronization with the cell and acquire the physical layer cell identity (ID) of the cell.

To perform a cell search, the UE needs to receive a primary synchronization signal (PSS) and a secondary synchronization signal (SSS). The UE assumes that the reception occasions of the physical broadcast channel (PBCH), the PSS and the SSS are consecutive symbols and form one SS/PBCH block.

After detecting an SS/PBCH block, the UE determines from the MIB whether a control resource set (CORESET) (or CORESET#0) of a Type0-PDCCH CSS (common search space) set is present. If k_{SSB}≤23 (for FR1) or if k_{SSB}≤11 (for FR2), it indicates that the control resource set of the Type0-PDCCH CSS set is present; and if k_{SSB}>23 (for FR1) or k_{SSB}>11 (for FR2), it indicates that the control resource set of the Type0-PDCCH CSS set is not present.

In September 2019, at the 3rd Generation Partnership Project (3GPP) RAN#86 Plenary Session, a new research project on support of reduced capability NR (5th generation wireless access technology) devices (see RP-193238: New SID on support of reduced capability NR devices) was approved. One of the goals of the research project described above is to support UE bandwidth reduction, but the SSB bandwidth of Rel-15 should be reused, and changes in a physical layer should be minimized.

In the email discussion on NR-light (see RP-192160: Summary of email discussion on NR-Light), many companies proposed that for FR1 (Frequency Range 1), the reduced UE bandwidth should be 5 MHz or 10 MHz.

The reduced capability NR equipment or NR UE refers to equipment or UE having a reduced complexity relative to Rel-15 NR equipment or NR UE. For example, a reduction in the number of UE receive/transmit (RX/TX) antennas, and/or a reduction in UE bandwidth, and/or half-duplex FDD, and/or relaxed UE processing time, and/or relaxed UE processing capability, and the like. The reduced capability NR equipment or NR UE may also be referred to as NR-light equipment or NR-light UE, or other names.

The bandwidths required in Rel-15 NR for receiving the SSB and SIB1 are shown in Table 4. The following is illustrated as an example of FR1. Referring to Table 4, if the maximum received bandwidth of the UE is 10 MHz, then the UE cannot receive all configurable CORESET#0 (or NR Rel-15 SIB1) bandwidths in NR, or only can receive a partial subset of a configurable CORESET#0 bandwidth set.

TABLE 4
Bandwidths required for receiving SSB and SIB1

| | FR1 | | | | FR2 | | | |
|---|---|---|---|---|---|---|---|---|
| SCS | 15 | kHz | 30 | kHz | 120 | kHz | 240 | kHz |
| SSB bandwidth | 3.6 | MHz | 7.2 | MHz | 28.8 | MHz | 57.6 | MHz |
| SCS | 15 | kHz | 30 | kHz | 60 | kHz | 120 | kHz |
| CORESET#0 bandwidth | 4.32/17.28 | MHz | 8.64/17.28 | MHz | 17.28/69.12 | MHz | 34.56/69.12 | MHz |
| (min/max) | | | | | | | | |

Note:
SCS: subcarrier spacing

Therefore, how to support reduced bandwidth UE in NR is a problem that must be solved.

The following describes the present invention in detail with reference to the accompanying drawings and specific embodiments. It should be noted that the present invention should not be limited to the specific embodiments described below. In addition, detailed descriptions of well-known technologies not directly related to the present invention are omitted for the sake of brevity, in order to avoid obscuring the understanding of the present invention.

The base station in the present invention is an entity for communicating with user equipment, and may also refer to a Node B or an evolved Node B (eNB) or a gNB (next generation NodeB) or an access point (AP).

The user equipment in the present invention may also refer to a terminal or an access terminal or a station or a mobile station or the like. The user equipment may be a cellular phone or a personal digital assistant (PDA) or a cordless telephone or a notebook computer or a mobile phone or a smart phone or a handheld device or a netbook or the like.

The physical downlink control channel in the present invention may refer to a PDCCH in 3GPP LTE/LTE-A (Long Term Evolution/Long Term Evolution-Advanced) or 5G NR, or an MPDCCH (MTC PDCCH) for machine-type communications, or an NPDCCH for narrowband Internet of Things communications or the like. The physical downlink shared channel may refer to a PDSCH in 3GPP LTE/LTE-A (Long Term Evolution/Long Term Evolution-Advanced) or 5G NR, or an NPDSCH for narrowband Internet of Things communications or the like.

The control resource set (CORESET) in the present invention is a time and frequency resource consisting of several resource blocks in the frequency domain and several symbols in the time domain.

The UE monitors, according to a corresponding search space set, a set of PDCCH candidates in one or more CORESETs on an active downlink bandwidth part (BWP) on each activated serving cell. The monitoring means decoding each PDCCH candidate according to the format of monitored downlink control information (DCI).

The information of the first CORESET (i.e. CORESET#0) is part of the initial bandwidth part configuration information. The information of the CORESET#0 is provided to the UE by the MIB. By means of the CORESET#0, the UE may obtain control information and know how to receive the remaining system information. When the connection is established, the base station configures multiple CORESETs for the UE by radio resource control (RRC) signaling.

The PDCCH monitoring occasion in the present invention refers to the time point at which the PDCCH is monitored in the time domain. The UE determines a PDCCH monitoring occasion on the active downlink BWP according to the PDCCH monitoring period, the PDCCH monitoring offset and the PDCCH monitoring mode within the time slot.

The UE determines, from searchSpaceZero in pdcch-configsibl, a PDCCH monitoring occasion for SIB1 reception.

The base station may support reduced capability UE on the basis of the field content (or parameters) already available in the MIB. Embodiments of the present disclosure are illustrated with specific embodiments below.

### Embodiment 1

In Embodiment 1, a spare bit and an SSB subcarrier offset (ssb-SubcarrierOffset, K_{SSB}) in an MIB are used for determining whether a base station supports reduced capability UE, and for determining a control resource set for receiving a reduced capability version of SIB1 and a PDCCH monitoring occasion, and the specific method is as follows:

after detecting an SS/PBCH block, the UE acquires, from the MIB, information of a spare character field (i.e., 1 bit of information) and K_{SSB} For FR2, the value of K_{SSB} is equal to the value of an ssb-SubcarrierOffset field in the MIB, ranging from 0 to 15. For FR1, the value of K_{SSB} is obtained from the ssb-SubcarrierOffset field and an additional most significant bit encoded in a physical broadcast channel (PBCH), ranging from 0 to 31.

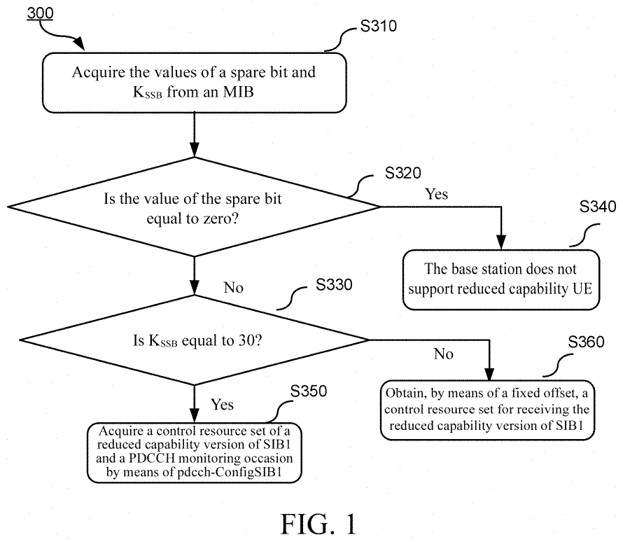

As shown in FIG. 1, in step S310, the UE acquires the value of a spare bit and K_{SSB} from the MIB, and then in step S320, the UE determines whether the value of the spare bit is equal to 0. If the value of the spare bit is equal to 0 (affirmative determination in step S320), it indicates that the base station does not support reduced capability UE (step S340). If the value of the spare bit is not equal to 0 or is equal to 1 (negative determination in step S320), it indicates that the base station supports reduced capability UE. For FR1, in step S330, whether the value of K_{SSB} is equal to 30 is further determined, or for FR2, whether the value of K_{SSB} is equal to 14 is further determined (not shown).

If K_{SSB}=30 or K_{SSB}=14 (affirmative determination in step S330), then in step S350, the pdcch-ConfigSIB1 field in the MIB is used for determining the control resource set of the reduced capability version of SIB1 and the PDCCH monitoring occasion. The determination method is the same as the method in which NR Rel-15 UE determines the control resource set and PDCCH monitoring occasion of the Type0-PDCCH common search space set by means of pdcch-ConfigSIB1 in the MIB (see non-patent literature: 3GPP TS 38.213 V15.7.0 (2019-09)).

If K_{SSB}≠30 or K_{SSB}≠14 (negative determination in step S330), then in step 360, a predefined (or preconfigured or fixed) PDCCH search space set is used for receiving the reduced capability version of SIB1, i.e., a predefined (or preconfigured or fixed) PDCCH search space set is used for determining the control resource set and the PDCCH monitoring occasion of the PDCCH search space set for receiving the reduced capability version of SIB1, wherein the control resource set of the PDCCH search space set may be obtained by means of a fixed (or configurable) offset relative to the detected SS/PBCH block in the frequency domain.

The offset may be a resource block (RB) offset value from the smallest RB index of the control resource set of the PDCCH search space set to the smallest RB index of a common RB overlapping with the first RB of the detected SS/PBCH block.

Alternatively, the offset may be a resource block (RB) offset value from the maximum RB index of the control resource set of the PDCCH search space set to the smallest RB index of a common RB overlapping with the last RB of the detected SS/PBCH block.

The bandwidth of the control resource set of the PDCCH search space set is in units of RB, and is equal to or less than the bandwidth of the reduced capability UE.

### Embodiment 2

In Embodiment 2, a spare bit in an MIB is used for determining whether a base station supports reduced capability UE, and for determining a control resource set for receiving a reduced capability version of SIB1 and a PDCCH monitoring occasion, and the specific method is as follows:

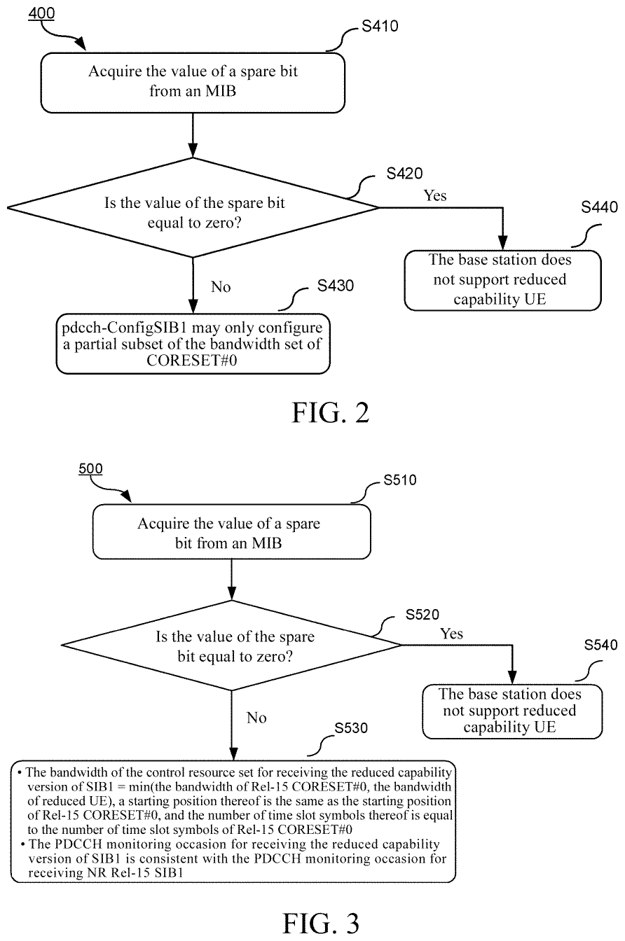

after detecting an SS/PBCH block, the UE acquires, from the MIB, information of a spare character field (i.e., 1 bit of information). As shown in FIG. 2, in step S410, the UE acquires the value of a spare bit from the MIB, and then in step S420, the UE determines whether the value of the spare bit is equal to 0. If the value of the spare bit is equal to 0 (affirmative determination in step S420), it indicates that the base station does not support reduced capability UE (step S440). If the value of the spare bit is not equal to 0 or is equal to 1 (negative determination in step S420), it indicates that the base station supports reduced capability UE. In step S430, the pdcch-ConfigSIB1 field in the MIB is used for determining the control resource set and the PDCCH monitoring occasion of the PDCCH search space set of the reduced capability version of SIB 1. The determination method is the same as the method in which NR Rel-15 UE determines the control resource set and PDCCH monitoring occasion of the Type0-PDCCH common search space set by means of pdcch-ConfigSIB1 in the MIB (see non-patent literature: 3GPP TS 38.213 V15.7.0 (2019-09)). In step S430, pdcch-ConfigSIB1 in the MIB may only configure a partial subset of a bandwidth set of a control resource set of the Rel-15 Type0-PDCCH common search space set, i.e., only the option of bandwidths equal to or less than the bandwidth of the supported reduced capability UE in the control resource set of the Rel-15 Type0-PDCCH common search space set may be configured. If the MIB received by the supported reduced capability UE indicates that the bandwidth of Rel-15 CERESET#0 is greater than the bandwidth of the supported reduced capability UE, then the supported reduced capability UE will consider that the MIB reception is wrong or that the base station does not support reduced capability UE. The parameter configuration of the PDCCH monitoring occasion is the same as the parameter configuration of the PDCCH monitoring occasion of the NR Rel-15 Type0-PDCCH common search space set, i.e., the parameter configuration of the PDCCH monitoring occasion is not affected.

### Embodiment 3

In Embodiment 3, a spare bit in an MIB is used for determining whether a base station supports reduced capability UE, and for determining a control resource set for receiving a reduced capability version of SIB1 and a PDCCH monitoring occasion, and the specific method as follows:

After detecting an SS/PBCH block, the UE acquires, from the MIB, information of a spare character field (i.e., 1 bit of information). As shown in FIG. 3, in step S510, the UE acquires the value of a spare bit from the MIB, and then in step S520, the UE determines whether the value of the spare bit is equal to 0. If the value of the spare bit is equal to 0 (affirmative determination in step S520), it indicates that the base station does not support reduced capability UE (step S540). If the value of the spare bit is not equal to 0 or is equal to 1 (negative determination in step S520), it indicates that the base station supports reduced capability UE. In step S530, the control resource set of the Rel-15 Type0-PDCCH common search space set and the configuration parameters of the PDCCH monitoring occasion are acquired by means of the pdcch-ConfigSIB1 field in the MIB. In particular, according to the acquired control resource set of the Rel-15 Type0-PDCCH common search space set and the configuration parameters of the PDCCH monitoring occasion, the control resource set of the PDCCH search space set of the reduced capability version of SIB1 and the PDCCH monitoring occasion are determined. The following operations are performed:

If the bandwidth in the control resource set of the Rel-15 Type0-PDCCH common search space set indicated by the pdcch-ConfigSIB1 in the MIB is equal to or less than the bandwidth of supported reduced capability UE, then the pdcch-ConfigSIB1 field in the MIB is directly used for determining the control resource set and the PDCCH monitoring occasion of the PDCCH search space set of the reduced capability version of SIB1. The determination method is the same as the method in which NR Rel-15 UE determines the control resource set and PDCCH monitoring occasion of the Type0-PDCCH common search space set by means of pdcch-ConfigSIB1 in the MIB (see non-patent literature: 3GPP TS 38.213 V15.7.0 (2019-09)). Or, at this time, the supported reduced capability UE and the NR Rel-15 UE share the same PDCCH common search space set to receive the reduced capability version of SIB1.

If the bandwidth in the control resource set of the Rel-15 Type0-PDCCH common search space set indicated by the pdcch-ConfigSIB1 in the MIB is greater than the bandwidth of the supported reduced capability UE, then the supported reduced capability UE uses a bandwidth part of the bandwidth in the control resource set of the Rel-15 Type0-PDCCH common search space set indicated by the pdcch-ConfigSIB1 in the MIB as the bandwidth of the control resource set for receiving the reduced capability version of SIB1, specifically as follows:

the bandwidth of the control resource set for receiving the reduced capability version of SIB1 is in units of RB, is equal to or less than the bandwidth of the supported reduced capability UE, and has a starting position in the frequency domain the same as the starting position of the bandwidth of the control resource set of the Rel-15 Type0-PDCCH common search space set indicated by the pdcch-ConfigSIB1 in the MIB.

The number of time slot symbols in the control resource set of the PDCCH search space set of the reduced capability version of SIB1 is consistent with the number of time slot symbols in the control resource set of the Rel-15 Type0-PDCCH common search space set indicated by the pdcch-ConfigSIB1 in the MIB.

The PDCCH monitoring occasion of the PDCCH search space set for receiving the reduced capability version of SIB1 is consistent with the PDCCH monitoring occasion of the Rel-15 Type0-PDCCH common search space set.

Alternatively, the bandwidth of the control resource set for receiving the reduced capability version of SIB1 is in units of RB, and is equal to or less than the bandwidth of the supported reduced capability UE. The control resource set of the reduced capability version of SIB1 and other parameters of the PDCCH monitoring occasion are consistent with the control resource set of the Rel-15 Type0-PDCCH common search space set indicated by the pdcch-ConfigSIB1 in the MIB and the parameters of the PDCCH monitoring occasion.

### Variant Embodiment

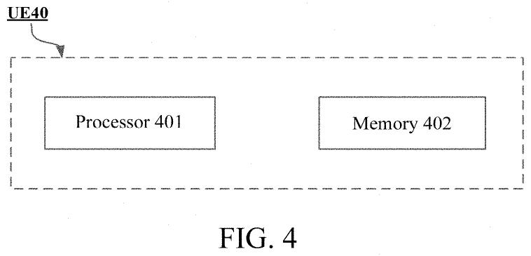

Hereinafter, FIG. 4 is used to illustrate user equipment that can perform the method performed by user equipment described in detail above in the present invention as a variant embodiment.

FIG. 4 is a block diagram showing the user equipment (UE) involved in the present invention.

As shown in FIG. 4, the user equipment (UE) 40 includes a processor 401 and a memory 402. The processor 401 may include, for example, a microprocessor, a microcontroller, an embedded processor, and the like. The memory 402 may include, for example, a volatile memory (such as a random access memory (RAM)), a hard disk drive (HDD), a non-volatile memory (such as a flash memory), or other memories. The memory 402 stores program instructions. The instructions, when run by the processor 401, can perform the above method performed by user equipment as described in detail in the present invention.

The methods and related equipment according to the present invention have been described above in combination with preferred embodiments. It should be understood by those skilled in the art that the methods shown above are only exemplary. The methods of the present invention are not limited to the steps or sequences illustrated above. The network node and user equipment shown above may include more modules; for example, the network node and user equipment may further include modules that can be developed or developed in the future to be applied to a base station or UE, and the like. Various identifiers shown above are only exemplary, and are not meant to limit the present invention. The present invention is not limited to specific information elements serving as examples of these identifiers. A person skilled in the art could make various alterations and modifications according to the teachings of the illustrated embodiments.

It should be understood that the above-described embodiments of the present invention may be implemented by software, hardware, or a combination of software and hardware. For example, various components inside the base station and the user equipment in the above embodiments may be implemented through various devices, which include, but are not limited to, analog circuit devices, digital circuit devices, digital signal processing (DSP) circuits, programmable processors, application specific integrated circuits (ASICs), field programmable gate arrays (FPGAs), programmable logic devices (CPLDs), and the like.

In the present invention, the term “base station” refers to a mobile communication data and control switching center with a large transmit power and a wide coverage area, and has functions of resource distribution scheduling, data receiving and transmitting, and the like. The term “user equipment” refers to a user mobile terminal, for example, a terminal device capable of performing wireless communication with a base station or a micro base station, including a mobile phone, a notebook computer and the like.

In addition, the embodiments of the present invention disclosed herein may be implemented on a computer program product. More specifically, the computer program product is a product provided with a computer-readable medium having computer program logic encoded thereon. When executed on a computing device, the computer program logic provides related operations to implement the above technical solutions of the present invention. When executed on at least one processor of a computing system, the computer program logic causes the processor to perform the operations (methods) described in the embodiments of the present invention. Such setting of the present invention is typically provided as software, codes and/or other data structures provided or encoded on the computer readable medium, e.g., an optical medium (e.g., compact disc read-only memory (CD-ROM)), a flexible disk or a hard disk and the like, or other media such as firmware or micro codes on one or more read-only memory (ROM) or random access memory (RAM) or programmable read-only memory (PROM) chips, or a downloadable software image, a shared database and the like in one or more modules. Software or firmware or such configuration may be installed on a computing device such that one or more processors in the computing device perform the technical solutions described in the embodiments of the present invention.

In addition, each functional module or each feature of the base station device and the terminal device used in each of the above embodiments may be implemented or executed by a circuit, which is usually one or more integrated circuits. Circuits designed to perform various functions described in this description may include general purpose processors, digital signal processors (DSPs), application specific integrated circuits (ASICs) or general purpose integrated circuits, field programmable gate arrays (FPGAs) or other programmable logic devices, discrete gates or transistor logic, or discrete hardware components, or any combination of the above. The general purpose processor may be a microprocessor, or the processor may be an existing processor, a controller, a microcontroller, or a state machine. The aforementioned general purpose processor or each circuit may be configured by a digital circuit or may be configured by a logic circuit. Furthermore, when advanced technology capable of replacing current integrated circuits emerges due to advances in semiconductor technology, the present invention can also use integrated circuits obtained using this advanced technology.

While the present invention has been illustrated in combination with the preferred embodiments of the present invention, it will be understood by those skilled in the art that various modifications, substitutions, and alterations may be made to the present invention without departing from the spirit and scope of the present invention. Therefore, the present invention should not be limited by the above-described embodiments, but should be defined by the appended claims and their equivalents.

1. A method performed by user equipment (UE), characterized by comprising:
detecting a synchronization signal/physical broadcast channel block, i.e. an SS/PBCH block;
determining, according to the detected SS/PBCH block and from a master information block (MIB), whether a base station transmitting the SS/PBCH block supports reduced capability UE; and
if so, determining a control resource set and a physical downlink control channel (PDCCH) monitoring occasion of a PDCCH search space set for receiving a reduced capability version of system information block 1, i.e. SIB1.

2. The method according to claim 1, wherein
a spare bit in the MIB and an SSB subcarrier offset K_{SSB} are used for determining whether the base station supports reduced capability UE, and for determining the control resource set and the PDCCH monitoring occasion of the PDCCH search space set for receiving the reduced capability version of SIB 1.

3. The method according to claim 2, wherein
if the value of the spare bit is a first value, it indicates that the base station does not support reduced capability UE;
if the value of the spare bit is a second value, it indicates that the base station supports reduced capability UE; and
in the event that the value of the spare bit is the second value,
if K_{SSB} is a given value, then the control resource set and the PDCCH monitoring occasion of the PDCCH search space set for receiving the reduced capability version of SIB1 are indicated by a pdcch-ConfigSIB1 parameter in the MIB; and
if K_{SSB} is not the given value, the control resource set and the PDCCH monitoring occasion of the PDCCH search space set for receiving the reduced capability version of SIB1 are determined by means of a predefined PDCCH search space set.

4. The method according to claim 3, wherein
the control resource set of the PDCCH search space set is obtained by means of a fixed offset relative to the detected SS/PBCH block in the frequency domain.

5. The method according to claim 1, wherein
a spare bit in the MIB is used for determining whether the base station supports reduced capability UE, and for determining the control resource set and the PDCCH monitoring occasion of the PDCCH search space set for receiving the reduced capability version of SIB 1.

6. The method according to claim 5, wherein
if the value of the spare bit is a first value, it indicates that the base station does not support reduced capability UE;
if the value of the spare bit is a second value, it indicates that the base station supports reduced capability UE; and
in the event that the value of the spare bit is the second value,
a pdcch-ConfigSIB1 parameter in the MIB may only configure a partial subset of a bandwidth set of a control resource set of the Type0-PDCCH common search space set, bandwidths in the subset being equal to or less than the bandwidth of the supported reduced capability UE.

7. The method according to claim 5, wherein
if the value of the spare bit is a first value, it indicates that the base station does not support reduced capability UE;
if the value of the spare bit is a second value, it indicates that the base station supports reduced capability UE; and
in the event that the value of the spare bit is the second value,
if the bandwidth in a control resource set of the Type0-PDCCH common search space set indicated by a pdcch-ConfigSIB1 parameter in the MIB is equal to or less than the bandwidth of the supported reduced capability UE, then the pdcch-ConfigSIB1 parameter in the MIB is directly used for determining the control resource set and the PDCCH monitoring occasion of the PDCCH search space set for receiving the reduced capability version of SIB1; and
if the bandwidth in the control resource set of the Type0-PDCCH common search space set indicated by the pdcch-ConfigSIB1 parameter in the MIB is greater than the bandwidth of the supported reduced capability UE, then the supported reduced capability UE uses a bandwidth part of the bandwidth in the control resource set of the Type0-PDCCH common search space set indicated by the pdcch-ConfigSIB1 parameter in the MIB as the bandwidth of the control resource set of the PDCCH search space set for receiving the reduced capability version of SIBl.

8. The method according to claim 7, wherein
the bandwidth of the control resource set of the PDCCH search space set for receiving the reduced capability version of SIB1 is equal to the bandwidth of the supported reduced capability UE, and has a starting position in the frequency domain the same as the starting position of the bandwidth of the control resource set of the Type0-PDCCH common search space set indicated by the pdcch-ConfigSIB1 parameter in the MIB.

9. The method according to claim 7, wherein
the number of time slot symbols in the control resource set of the PDCCH search space set for receiving the reduced capability version of SIB1 is consistent with the number of time slot symbols in the control resource set of the Type0-PDCCH common search space set indicated by the pdcch-ConfigSIB1 parameter in the MIB; and
the PDCCH monitoring occasion of the PDCCH search space set for receiving the reduced capability version of SIB1 is consistent with the PDCCH monitoring occasion of the Type0-PDCCH common search space set.

10. User equipment, comprising:
a processor; and
a memory storing instructions,
wherein the instructions, when run by the processor, perform the method according to any one of claims 1 to 9.
